(19) United States
(12) Patent Application Publication
(10) Pub. No.: US 2010/0306039 A1
(43) Pub. Date: Dec. 2, 2010

(54) TECHNIQUES FOR CUSTOMIZED DELIVERY OF ADVERTISEMENTS

(75) Inventors: Martin Green, San Francisco, CA (US); Andreas Binnewies, Berkeley, CA (US); Kevin Ferguson, San Francisco, CA (US); Michael Pat Becker, Brooklyn, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Meebo, Inc., Mountain View, CA (US)

(21) Appl. No.: 12/790,494

(22) Filed: May 28, 2010

Related U.S. Application Data
(60) Provisional application No. 61/226,644, filed on Jul. 17, 2009.
(60) Provisional application No. 61/183,471, filed on Jun. 2, 2009.

(51) Int. Cl. G06Q 30/00

(52) U.S. Cl. 705/14.4

(57) ABSTRACT

Techniques for customizing the delivery of advertisements to a client. In one embodiment, the customization comprises dynamically determining a length of time for an advertisement, where the length of time represents the minimum amount of time for which the advertisement is to be output (e.g., displayed) by a client. The length of time may be dynamically determined on a per-advertisement based upon multiple criteria.

### CROSS-REFERENCES TO RELATED APPLICATIONS

The present application claims the benefit and priority under 35 U.S.C. 119(e) from the following provisional applications, the entire contents of which are herein incorporated by reference for all purposes:

(1) U.S. Provisional Application No. 61/183,471, filed Jun. 2, 2009, entitled TECHNIQUES FOR DISPLAYING AN ADVERTISEMENT ACROSS MULTIPLE PAGES; and

(2) U.S. Provisional Application No. 61/226,644, filed Jul. 17, 2009, entitled TECHNIQUES FOR CUSTOMIZED DELIVERY OF ADVERTISEMENTS.

The present application also incorporates by reference for all purposes the entire contents of U.S. Non-Provisional application Ser. No. ______ (Attorney Docket No. 028013-000110US) titled TECHNIQUES FOR DISPLAYING AN ADVERTISEMENT ACROSS MULTIPLE PAGES filed concurrently with the present application.

### BACKGROUND

Embodiments of the present invention are related to delivering information to clients, and more particularly to techniques for customizing the delivery of advertisements to clients.

Many online services and vendors exist that serve advertisements to be displayed at a client device such as a desktop computer, a mobile device, and the like. In a typical setting, a user may use a browser executing on a client machine (e.g., a desktop computer, a smart phone, etc.) to access web pages from one or more websites. One or more advertisements may be served to and displayed by the client machine during the user's browsing session. Conventionally, an advertisement is displayed by the client machine each time a new web page is loaded and displayed by the browser. Accordingly, the display of advertisements is closely coupled to the page views.

The advertisements may be served by one of several advertisement-server vendors such as Meebo™, Yahoo™, Google™, MSN™, AOL™, and others. An advertisement-server vendor may serve advertisements provided by one or more advertisers. Various revenue models exist by which an advertisement-server vendor generates revenues from serving advertisements. The most popular model is the Cost Per Click (CPC) or Pay Per Click (PPC) model. According to the CPC model, an advertiser pays the advertisement-server vendor each time a user clicks or engages (referred to as a click-through) the displayed advertisement and is redirected to a particular website corresponding to the advertisement (typically the website of an advertiser). In the CPC model, the revenue generated by an advertisement-server vendor is directly proportional to the number of advertisement engagements (clicks). A click-through rate (CTR) measured based upon the number of click-throughs is also used by advertisers to measure the success of their advertisement campaigns. Accordingly, higher click rates for advertisements are beneficial to both the ad-server vendor and the advertiser. Various other revenue models may also be used such as the Cost Per View (CPV) according to which an advertisement-server vendor is paid by an advertiser for each unique user view of an advertisement provided by the advertiser.

It is well accepted that the time for which an advertisement is shown to a user greatly impacts the engagement or click rate for the advertisement, which in turn impacts the revenues gained from the advertisement both by the ad-server vendor and the advertiser. However, as indicated above, conventionally, an advertisement is displayed by a client each time a web page is loaded and displayed by the client machine. The time for which advertisements are displayed to a user is thus completely dependent upon the rate at which new web pages are displayed to the user. This one-size-fits-all approach is however not beneficial to advertisement-server vendors or to advertisers from a perspective of revenue generation.

### BRIEF SUMMARY

Embodiments of the present invention provide techniques for customizing the delivery of advertisements to a client. In one embodiment, the customization comprises dynamically determining a length of time for an advertisement, where the length of time represents the minimum amount of time for which the advertisement is to be output (e.g., displayed) by a client. The length of time for an advertisement may be determined dynamically based upon multiple criteria. The length of time may be determined dynamically on a per-advertisement-basis.

In one embodiment, techniques are provided for determining time information for an advertisement based upon a set of one or more criteria, where the time information indicates a length of time for outputting the advertisement at a client system. The time information that is determined for the advertisement may be communicated to the client system. The client system may then cause the advertisement to be output at least the length of time indicated by the time information. Depending upon the length of time, the same advertisement may be persisted across multiple web pages loaded by the client. Alternatively, the length of time may be such that multiple advertisements are displayed during a single page view. For example, a new advertisement may be displayed when the user clicks on the page without calling a new page view. In one embodiment, the time information for an advertisement is determined responsive to a request received from the client system requesting a length of time for the advertisement.

In one embodiment, time information is computed on a per-advertisement basis. Accordingly, a second time information may be determined for a second advertisement based upon the set of one or more criteria, where the second time information specifies a length of time for outputting the second advertisement at the client system. The second time information may then be communicated to the client system. The client system may then cause the second advertisement to be displayed for at least the length of time specified by the second information. The length of time specified for different advertisements may be different. In one embodiment, the client system may output a first advertisement for at least a length of time computed for the first advertisement and output a second advertisement for at least a length of time computed for the second advertisement. The first advertisement and second advertisement may be output by the client system while the client system is engaged in a session with a website during which one or more web pages from the website are loaded and displayed by the client system.

Various different criteria may be used for determining the time information for an advertisement. The criteria may include but is not restricted to a geographic location of the client system or of a user of the client system, information related to the user of the client system, information related to a website, characteristics of the advertisement, a campaign goal for the advertisement, or the next advertisement to be displayed. In one embodiment, a first criterion may be selected from the set of criteria and used for determining the time information for the advertisement. The first criterion may be selected from the set of criteria based upon a priority assigned to each criterion in the set of criteria.

The foregoing, together with other features and embodiments will become more apparent upon referring to the following specification, claims, and accompanying drawings.

### BRIEF DESCRIPTION OF THE DRAWINGS

FIG. 1 is a simplified block diagram of a network environment that may incorporate an embodiment of the present invention;

FIG. 2 depicts a sample web page and accompanying bar displayed by an ad-client according to an embodiment of the present invention;

FIG. 3 is a simplified block diagram showing interactions between an ad-client, an ad-optimizer, and an ad-server according to an embodiment of the present invention;

FIG. 4 is a simplified block diagram showing interactions between an ad-client and a combined ad-optimizer/ad-server system according to an embodiment of the present invention; and

FIG. 5 is a simplified block diagram of a computer system that may be used to practice an embodiment of the present invention.

### DETAILED DESCRIPTION

In the following description, for the purposes of explanation, specific details are set forth in order to provide a thorough understanding of embodiments of the invention. However, it will be apparent that the invention may be practiced without these specific details.

Embodiments of the present invention provide techniques for customizing the delivery of advertisements to a client. In one embodiment, the customization comprises dynamically determining a length of time for an advertisement, where the length of time represents the minimum amount of time for which the advertisement is to be output (e.g., displayed) by a client.

In one embodiment, the length of time for an advertisement may be dynamically determined based upon multiple criteria (or variables). The length of time may be determined dynamically on a per advertisement-basis. The rotation of advertisements (advertisement rotation) displayed at a client may thus be customized. In one embodiment, the length of time for an advertisement is determined with the goal of optimizing the revenue potential for an advertisement-server vendor serving the advertisement.

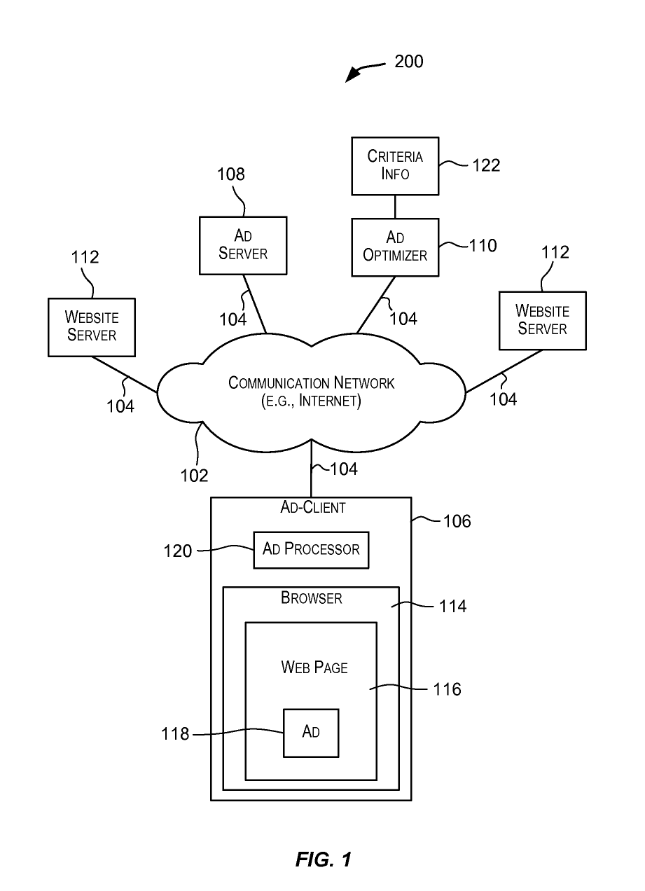

FIG. 1 is a simplified block diagram of a network environment 100 that may incorporate an embodiment of the present invention. The embodiment depicted in FIG. 1 is merely an example and is not intended to unduly limit the scope of embodiments of the present invention as recited in the claims. One of ordinary skill in the art would recognize many variations, alternatives, and modifications.

As depicted in FIG. 1, environment 100 comprises multiple systems communicatively coupled to each other via communication network 102. Communication network 102 may be the Internet, an Intranet, a local area network (LAN), a wide area network (WAN), an Ethernet network, or any communication network/infrastructure that enables communications between the various systems. Communication network 102 may comprise one or more communication networks. A variety of communication protocols, including wired and wireless protocols, may be used for data communications over network 102 including but not limited to TCP/IP, SNA, IPX, AppleTalk, IEEE 802.XX (suite of protocols, the Bluetooth protocol, and/or other protocols or combination of protocols. The various systems depicted in FIG. 1 may be coupled to communication network 102 via links 104, which may include wired or wireless links.

The systems depicted in FIG. 1 include an advertisement-client system (ad-client) 106, an advertisement-server system (ad-server) 108, an advertisement-optimizer (ad-optimizer) system 110, and website server systems 112. Ad-client 106 may be any system that is configured to receive one or more advertisements and to output (e.g., display) the received advertisements. Examples of ad-clients 106 include but are not restricted to a desktop computer, a laptop, a mobile device (e.g., a smart phone such as iPod, Blackberry, or Palm device), a display, a kiosk, and the like. In the embodiment depicted in FIG. 1, ad-client 106 is in the form of a computer that may be used by a user to perform web browsing. The user may use an application such as browser 114 executing on ad-client 106 to access web pages 116 from one or more websites hosted by website servers 112. Examples of browsers include different versions of Windows Internet Explorer, Mozilla Firefox, Apple Safari, Google Chrome, Opera, and others. A user may access a web page by providing a Uniform Resource Locator (URL) corresponding to a web page to browser 114 or by taking an action (e.g., clicking on a URL) that invokes a URL. The web page (or in general, any document) corresponding to the URL is then loaded and displayed by browser 114.

Ad-client 106 may be configured to output one or more advertisements 118, which may be served to ad-client 106 by ad-server 108. Ad-server 108 may be configured to serve an advertisement to ad-client 106 in response to an advertisement request received from the ad-client 106. An advertisement received by ad-client 106 from ad-server 108 may be output via an output device of ad-client 106. For example, the advertisement may be displayed on a display of ad-client 106. For example, in one embodiment, while a user is accessing one or more pages from a website (i.e., during a user's session with a website), ad-client 106 may send one or more advertisement requests to ad-server 108, receive one or more advertisements from ad-server 108, and display the received advertisements.

According to an embodiment of the present invention, in addition to receiving an advertisement, ad-client 106 also receives time information for the advertisement. Ad-client 106 is configured to cause the advertisement to be displayed for at least a length of time indicated by the time information for the advertisement. In one embodiment, the length of time for an advertisement is determined by ad-optimizer 110. For an advertisement served to ad-client 106 by ad-server 108, ad-client 106 receives timing information for that advertisement from ad-optimizer 110, where the timing information indicates a length of time that the advertisement is to be displayed by ad-client 106. Ad-client 106 then causes the advertisement to be displayed for at least the length of time specified by the timing information received for the advertisement.

As indicated above, ad-client 106 is configured to display the advertisement for at least a length of time specified by the time information for the advertisement. In one embodiment, after the length of time has passed, a subsequent user action (e.g., a user click) may cause a new advertisement request to be communicated from ad-client 106 to ad-server 108. The previous advertisement displayed by ad-client 106 may then be replaced by a new advertisement received by ad-client 106 from ad-server 108 in response to the new advertisement request. New timing information may be received for the new advertisement and ad-client 106 may cause the new advertisement to be displayed for at least the length of time indicated by the new timing information.

In the manner described above, ad-client 106 causes an advertisement to be displayed for at least the length of time specified by the timing information received for the advertisement by ad-client 106 from ad-optimizer 110. The length of time information determined for an advertisement may be specified in different ways. In one embodiment, the length of time may be specified as a period of time such as 30 seconds, 2 minutes, 5 minutes, etc. In another embodiment, the length of time may be specified as a time until which the advertisement is to be displayed such as 11:30 am, 1:35 pm, etc. Ad-client 106 is configured to track the passage of time and cause the advertisement to be displayed for at least the specified length of time. Further details related to interactions between ad-client 106, ad-server 108, and ad-optimizer 110 are described below.

As described above, in one embodiment, the length of time for which an advertisement is displayed by ad-client 106 is based upon the timing information determined for the advertisement by ad-optimizer 110. The length of time for which an advertisement is displayed is decoupled from loading/unloading of page views. Depending upon the length of time determined for an advertisement, the same advertisement may be displayed across multiple web page views. Details related to how an advertisement may be persisted across multiple page views are described in U.S. Provisional Application No. 61/183,471 filed Jun. 2, 2009, and in U.S. Non-Provisional application Ser. No. ______ (Attorney Docket No. 028013-000110US) titled TECHNIQUES FOR DISPLAYING AN ADVERTISEMENT ACROSS MULTIPLE PAGES filed concurrently with the present application—the entire contents of these applications are incorporated herein by reference for all purposes. Alternatively, if the time spent by a user on a web page is greater than the length of time determined by ad-optimizer 110 for displaying an advertisement, then multiple advertisements may be displayed by ad-client 106 during the web page view. Embodiments of the present invention decouple the length of time for which an advertisement is displayed by an ad-client from the loading and displaying of web pages by the ad-client.

In the embodiment depicted in FIG. 1, advertisement-related processing performed on ad-client 106 is performed by advertisement processor module 120. Ad processor module 120 may be implemented in software (e.g., code, program, instructions) that is executed by a processor of ad-client 106, in hardware, or combinations thereof. The software may be stored on a non-transitory computer-readable storage medium. The processing performed by ad processor 120 may include generating advertisement requests, receiving advertisements served by ad-server 108, receiving time information for the advertisements from ad-optimizer 110, and causing an advertisement to be output by ad-client 106 for at least a length of time as specified in the time information associated with the advertisement.

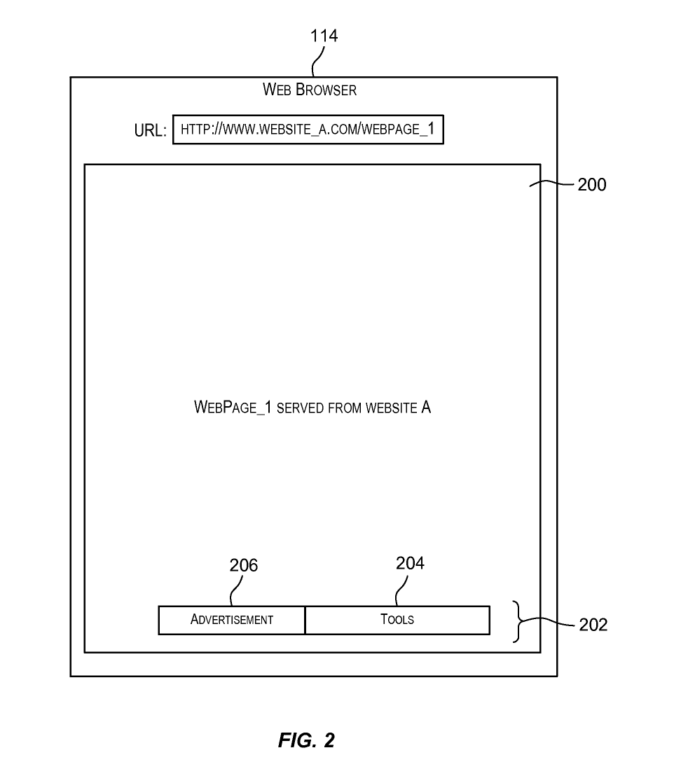

There are different ways in which an advertisement may be displayed on an ad-client. In one embodiment, a 3^{rd} party may be syndicated to provide services for one or more websites. For example, Meebo™ is syndicated by several websites to provide tools that enable instant messaging (IM) related services. In one embodiment, as depicted in FIG. 2, for a web page 200 served to an ad-client from a syndicated website and displayed by browser 114, a bar 202 comprising the tools is displayed overlaid on the web page. Bar 202 may comprise a section 204 that comprises the tools that enable instant messaging (IM) related services. Advertisements that are received and displayed by ad-client 106 may be displayed in another section 206 of bar 202, as depicted in FIG. 2. The advertisement may be displayed by ad-client 106 for at least a length of time computed for the advertisement by ad-optimizer 110.

As described above, ad-server 108 is configured to serve advertisements to ad-client 106. A single ad-server 108 may serve advertisements to one or more ad-clients (even though only one ad-client is depicted in FIG. 1). In one embodiment, the advertisements may be served to the ad-clients in response to advertisement requests received from the ad-clients.

Ad-server 108 may host advertisements provided by one or more advertisers and serve the advertisements to one or more ad-clients. The vendor of ad-server 108 may generate revenues from serving the advertisements. Various revenue models exist by which an ad-server vendor generates revenues from serving advertisements provided by advertisers including but not limited to Cost Per Click (CPC) or Pay Per Click (PPC) model and the Cost Per View (CPV) model. According to the CPC model, an advertiser pays the ad-server vendor each time a user clicks (or engages) a served advertisement. Clicking or engaging the advertisement may redirect the user to a particular website corresponding to the advertisement (typically the website of the advertiser). In a CPC model, the revenue generated by an ad-server vendor is directly proportional to the number of advertisement engagements (clicks). In the Cost Per View (CPV) model, an ad-server vendor is paid by an advertiser for each unique user view of an advertisement provided by the advertiser. Examples of ad-server vendors include Meebo™, Yahoo™, Google™, MSN™, AOL™, and others.

Ad-optimizer 110 is configured to perform processing to dynamically determine time information for an advertisement, where the time information indicates a minimum length of time for which the advertisement is to be displayed by an ad-client. Ad-optimizer 110 may communicate the time information to ad-client 106. In one embodiment, ad-optimizer 110 is configured to determine/compute the length of time for an advertisement based upon various criteria. Examples of criteria that may be used for the computation include but are not restricted to the type of web site involved in the user session (e.g., whether it is a social networking website such as Facebook™, a video streaming web site, an online gaming website, a news website, etc.), the geographical location of ad-client 106 or the user, the design and/or contents of the advertisement (also referred to as the “ad creative”), and other criteria. As part of the processing, ad-optimizer 110 may access criteria information 122 storing information related to the set of criteria. Criteria information 122 may be stored by ad-optimizer 110. The criteria information or portions thereof may also be provided to ad-optimizer 110 by ad-client 106 or by ad-server 108. Examples of criteria and how they impact determination of the length of time for an advertisement are discussed below.

In one embodiment, ad-optimizer 110 is configured to determine time information for an advertisement with a view towards optimizing the ad-server vendor's revenue generation potential from the advertisement per minute of user time. For example, during 5 minutes of usage over several page views, one particular combination of the number of advertisements multiplied by the revenue per advertisement (# of ads×Revenue per ad) may be optimal. In this embodiment, the goal of ad-optimizer 110 in computing a length of time for an advertisement is to maximize the ad-server vendor's revenue generation potential from that advertisement. For example, the length of time for an advertisement may be determined such that it increases the probability that a user will click-through or engage the advertisement, thereby generating revenues for the ad-server vendor per the CPC model. In this embodiment, the criteria used by ad-optimizer 110 for determining the length of time for an advertisement may also include information related to the revenue model being used. For example, advertisements from different advertisers may have different associated CPC revenue models. For instance, a click-through for a financial services advertisement may generate more revenue than a click-through for a movie advertisement. This information related to terms of the revenue model being used may be made available to ad-optimizer 110.

In the example described above, the goal of the processing performed by ad-optimizer 110 is to maximize ad-server vendor revenue generation potential. In an alternative embodiment, ad-optimizer 110 may be configured to determine a length of time for an advertisement based upon other goals, such as to improve a user's browsing session experience. For example, the time lengths for advertisements may be calculated such that the user is shown an appropriate number of advertisements that do not diminish the user's browsing experience.

In FIG. 1, web pages served to an ad-client 106 may be served from one or more website servers 112. Website servers 112 may host one or more websites, each website comprising one or more web pages that may be accessed by an ad-client. The websites may include page-view based websites and/or non page-view based websites. Certain websites may require a user to login to the website (e.g., using a user ID and login password) before the user can access pages provided by the website. For example, a website such as Facebook™ requires a user to login before the user can access web pages provided by the website. For a website that requires user login, a user typically has to first register and open an account with the website. The information provided by the user during the account opening or registration may be stored by the website. In one embodiment, this user-related information may be used by ad-optimizer 110 as part of the criteria for determining time information for an advertisement.

As described above with respect to FIG. 1, ad-client 106 is described as a computer that enables a user to access web pages provided by one or more websites and that can display advertisements during the user's browsing session. The ability to perform web browsing or the ability to load/unload web pages is however not essential to embodiments of the present invention. Any ad-client that can receive and output advertisements can reap the benefits of embodiments of the present invention. There is no requirement that the advertisements have to be displayed during a browsing session. For example, the ad-client may simply be a device that can receive and display advertisements such that an advertisement is displayed for at least a length of time determined for the advertisement by ad-optimizer 110.

In the embodiment depicted in FIG. 1, ad-optimizer 110 is shown as a separate system from ad-server 108 and from ad-client 106. This architecture enables changes to be made to ad-optimizer 110 without affecting either ad-server 108 or ad-client 106. For example, processing performed by ad-optimizer 110 may be changed without affecting ad-server 108 or ad-client 106. In this architecture, a single ad-optimizer 110 may provide services for multiple ad-servers and for multiple ad-clients. Further, in this architecture ad-server 108 and ad-client 106 do not have to access or even need to know the logic used by ad-optimizer 110 for determining times for advertisements. The processing for determining time information for an advertisement may be self-contained within the confines of ad-optimizer 110 thereby providing for improved security.

In alternative embodiments, the processing and services provided by ad-optimizer 110 may be combined with one or more other systems. For example, in one embodiment, the functionality of ad-optimizer 110 may be incorporated into ad-server 108. A single system (or set of systems) may be provided that provides services offered by both ad-server 108 and ad-optimizer 110. In another embodiment, the functionality of ad-optimizer 110 may be implemented in ad-client 106.

Although a single ad-client 106 is depicted in FIG. 1, multiple ad-clients may be present in alternative embodiments. A single ad-server 108 and ad-optimizer 110 may service multiple ad-clients. Likewise, a single ad-client may be served advertisements by multiple ad-servers. The ad-client may receive time information for the advertisements from one or more ad-optimizers. A single ad-server 108 may use the services of one or more ad-optimizers. A single ad-optimizer 110 may provide services for multiple ad-servers.

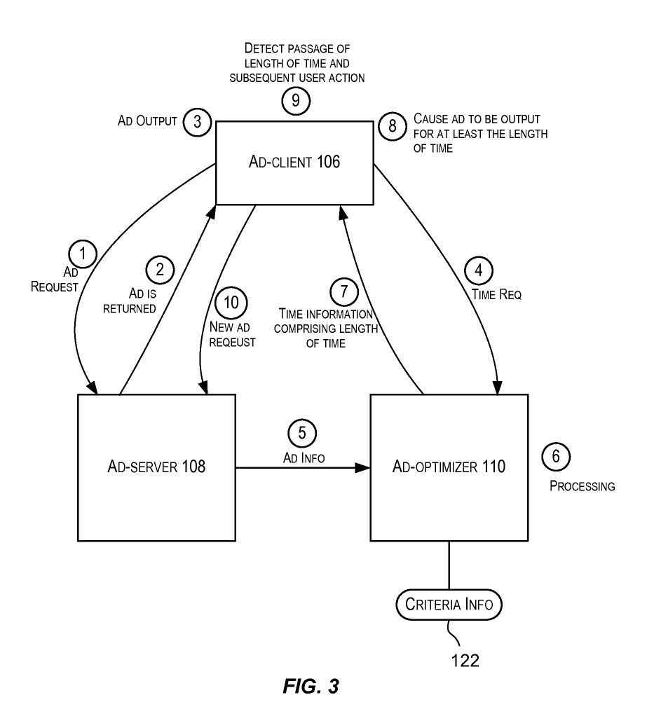

FIG. 3 is a simplified block diagram showing interactions between an ad-client, an ad-optimizer, and an ad-server according to an embodiment of the present invention. The embodiment depicted in FIG. 3 assumes that the ad-optimizer and the ad-server are separate systems. The set of interactions depicted in FIG. 3 is merely an example of interactions that may occur in an embodiment of the invention and are not intended to limit the scope of embodiments of the present invention as recited in the claims. One of ordinary skill in the art would recognize many variations, alternatives, and modifications. In the embodiment depicted in FIG. 3, ad-optimizer 110 may be provided by a vendor such as Meebo™. Ad-server 108 may be provided by a third party such as Meebo™, Inc. and others.

As depicted in FIG. 3, in a first step (1), a request for an advertisement is communicated from ad-client 106 to ad-server 108. In response, ad-server 108 serves an advertisement to ad-client 106 (step (2)). Ad-client 106 may output (e.g., display) the advertisement received from ad-server 108 (step (3)).

Ad-client 106 sends a request to ad-optimizer 110 requesting time information from ad-optimizer 110 for the advertisement received and displayed by ad-client 106 (step (4)). The request may comprise information related to the particular advertisement displayed by ad-client 106 and request time information for the advertisement. The request communicated from ad-client 106 to ad-optimizer 110 may also comprise information that may be used by ad-optimizer 110 to determine the time information for the advertisement. For example, the request may comprise information related to one or more criteria that are used by ad-optimizer 110 for determining time information for the advertisement. For example, the information communicated to ad-optimizer 110 in (4) may include information describing the advertisement (i.e., information related to the ad creative), information identifying the location of the ad-client or user, information related to a web page presently viewed by the user on the ad-client, information related to a website from where the presently viewed web page is served, and other information. If the user has logged into a website, information stored by that website for the user or a portion thereof may also be communicated to ad-optimizer 110.

In one embodiment, ad-server 108 may also send information to ad-optimizer 110 that may be used by ad-optimizer 110 to compute the time information for the advertisement (step (5)). In this manner, the information that is used by ad-optimizer 110 for determining time information for an advertisement may be received from ad-client 106 and/or from as-server 108. Ad-optimizer 110 may also store information that is used for computation of the time information for an advertisement.

Ad-optimizer 110 is then configured to perform processing to determine time information for the advertisement (step (6)). The time information specifies a minimum length of time for which the advertisement is to be displayed by ad-client 106. The processing performed by ad-optimizer 110 may be based upon information received from ad-client 106, or from ad-server 108, or based upon criteria information 122 accessible to ad-optimizer 110.

Ad-optimizer 110 is configured to respond to ad-client 106 by sending the computed time information to ad-client 106 (step (7)). Ad-client 106 then causes the advertisement to be output for at least the length of time specified in the time information received from ad-optimizer 110 for the advertisement (step (8)). There are different ways in which an advertisement may be output by ad-client 106. For example, ad-client 106 may cause the advertisement to be output by displaying the advertisement on a screen/display. The advertisement may also be output using other output devices such as audio output devices. Accordingly, ad-client 106 may use different output techniques or combinations thereof to output the advertisement for at least the length of time determined for that advertisement by ad-optimizer 110. Ad-client 106 may track the passage of time and display the advertisement for at least the length of time indicated by the time information received from ad-optimizer 110.

Depending upon the length of time determined for which an advertisement is to be output, the advertisement may be persisted across multiple web page views. For example, an advertisement may be displayed by an ad-client while a first web page is accessed by a user of the ad-client and the same advertisement may continue to be displayed by the ad-client when the user accesses a second web page. Alternatively, if the time spent by a user on a web page is greater than the length of time determined by ad-optimizer 110 for the advertisement, then multiple advertisements may be displayed during the web page view.

In one embodiment, ad-client 106 is configured to track the passage of time and detect when the length of time for the advertisement has passed (step (9)). Ad-client 106 may also be configured to detect a user action subsequent to the passage of the minimum length of time. After the length of time has passed, a subsequent user action (e.g., a user click) may cause ad-client 106 to send a new advertisement request to ad-server 108 (step (10)). The various processing steps (2) to (9) depicted in FIG. 3 may then be repeated for the new advertisement request.

The time information communicated from ad-optimizer 110 to ad-client 106 for an advertisement may be in different formats. In one embodiment, time information may indicate the length of time as a period of time such as 30 seconds, 2 minutes, 5 minutes, etc. In this embodiment, based upon the time when the advertisement display was initiated by ad-client 106 and based upon the length of time received from ad-optimizer 110, ad-client 106 may then determine a time until which the advertisement is to be displayed.

In another embodiment, the time information received from ad-optimizer 110 may indicate the length of time by specifying a time point until which the advertisement is to be displayed such as 11:30 am, 1:35 pm, etc. The advertisement is then displayed by ad-client 106 at least until the time received by the ad-client from the ad-optimizer for that advertisement. In such an embodiment, information indicating when display of the advertisement was initiated by ad-client 106 may be communicated to ad-optimizer 110 in step (4). Ad-optimizer 110 may then respond back by indicating an absolute time until which the advertisement should be displayed by ad-client 106.

For each system depicted in FIG. 3, the processing performed by the system may be performed by software (e.g., code, program, instructions) executed by one or more processors of the system, by hardware, or combinations thereof. The software may be stored on a non-transitory computer readable-storage medium.

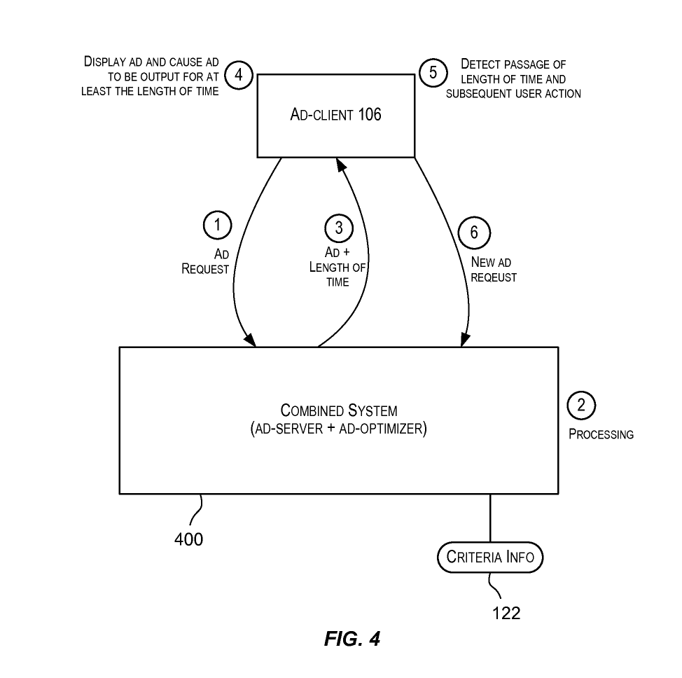

FIG. 4 is a simplified block diagram showing interactions between an ad-client and a combined ad-optimizer/ad-server system according to an embodiment of the present invention. The interactions depicted in FIG. 4 are merely examples of interactions that may occur in an embodiment of the invention and are not intended to limit the scope of embodiments of the present invention as recited in the claims. One of ordinary skill in the art would recognize many variations, alternatives, and modifications. In the embodiment depicted in FIG. 4, combined system 400 may be provided by Meebo™.

In this embodiment, processing may be initiated when ad-client 106 communicates a request for an advertisement to combined system 400 (step (1)). In response, combined system 400 performs processing to determine time information for the advertisement (step (2)). The processing performed by combined system 400 may be based upon information received by combined system 400 from ad-client 106 and/or based upon criteria information 122 stored by combined system 400. Combined system 400 then communicates an advertisement and the length of time information computed for that advertisement to ad-client 106 (step (3)). Ad-client 106 then causes the advertisement received from combined system 400 to be output for at least the length of time indicated by the time information received for the advertisement from combined system 400 (step (4)). After the length of time specified by the time information has passed and upon a subsequent action (e.g., a subsequent user click) (step (5)), ad-client 106 may send a new advertisement request to combined system 400 (step (6)). The various processing steps (2) to (5) depicted in FIG. 4 may then be repeated for the new advertisement request.

For each system depicted in FIG. 4, the processing performed by the system may be performed by software (e.g., code, program, instructions) executed by one or more processors of the system, by hardware, or combinations thereof. The software may be stored on a non-transitory computer readable-storage medium.

As described above, ad-optimizer 110 may dynamically determine a length of time for each advertisement displayed by ad-client 106 and ad-client 106 may cause an advertisement to be output for at least the length of time determined for that advertisement. This in turn determines when the next advertisement will be displayed by ad-client 106. In this manner, the length of time determined for an advertisement impacts the advertisement rotation time. This affects the number of advertisements that are displayed by ad-client 106 during a user's session with one or more websites.

The length of time for which an advertisement is to be displayed is dynamically determined for each advertisement based upon a set of criteria. The length of time computed for an advertisement displayed during a user's session with a first website may be different from the amount of time computed for the same advertisement displayed during the user's session with a second website that is different from the first website. Further, for advertisements displayed during a user's session with a website, the length of time determined for one advertisement may be different from the length of time determined for another advertisement. Accordingly, the lengths of time for displaying advertisements may be dynamically changed during a user's session.

As described above with respect to FIGS. 3 and 4, in one embodiment, ad-client 106 may send a new advertisement request upon expiration of the minimum length of time computed for the advertisement and a subsequent user action such as a user click, rather than just upon expiration of the length of time. This is to ensure that the user is actually viewing the advertisement. It may be possible that the user has just walked away from the ad-client, in which case displaying a new advertisement merely upon expiration of the minimum time length associated with the present advertisement (i.e., solely on a time-basis) does not ensure that the user will actually view the new advertisement. Instead, a user action such as a user click indicates that the user is present at the ad-client and will likely view the new advertisement being served. Accordingly, an advertisement call is typically initiated upon a user click subsequent to expiration of the length of time determined by ad-optimizer 110 for the currently displayed advertisement. This is however not intended to limit the scope of the present invention as recited in the claims. In alternative embodiments, a new advertisement request may be initiated simply upon expiration of the length of time computed for the previous advertisement or in combination with some other triggering event.

As described above with respect to FIGS. 3 and 4, ad-optimizer 110 dynamically determines the length of time for which an advertisement is to be displayed on a per-advertisement basis. In one embodiment, the length of time determination for each advertisement is done such that it optimizes the revenue generation potential for the ad-server vendor. For example, in one embodiment, the length of time determined for an advertisement is such that it optimizes the chance of the user clicking/engaging the advertisement, which in turn generates revenues for the ad-server vendor. In alternative embodiments, ad-optimizer 110 may be configured to determine the length of time for an advertisement to optimize other goals. For example, in one embodiment, the length of time for which an advertisement is displayed may be optimized to enhance a user's browsing experience. Other goals may be specified in alternative embodiments.

In the embodiments described above, the ad-optimizer determines a length of time for an advertisement displayed by an ad-client, conveys the time information to the ad-client, and the ad-client is then configured to output the advertisement for at least the length of time computed by the ad-optimizer. In some embodiments, the ad-optimizer may be configured to send one or more updates to the ad-client that update the initial length of time determined for the advertisement by the ad-optimizer and conveyed to the ad-client. The ad-client is then configured to adjust its timer to calculate a new remaining time for which the advertisement is to be displayed based upon the updated time information received from the ad-optimizer.

For example, the ad-optimizer may compute and communicate to the ad-client that a particular advertisement is to be displayed for a minimum of 5 minutes. Subsequent to conveying this time information to the ad-client, ad-optimizer may receive information that the user of the ad-client is 25 years old. This information may cause a re-computation of the length of time for the particular advertisement. Based upon this additional received information, the ad-optimizer may compute a new length of time for the particular advertisement of 3 minutes. Ad-optimizer may then communicate this new time information to the ad-client. Upon receiving the update from the ad-optimizer, ad-client is configured to adjust its timer to calculate a new remaining time for which the particular advertisement is to be displayed. For example, if more than 3 minutes have already elapsed for displaying the advertisement, then the ad-client sends a new advertisement request on the next user action. If on the other hand, less than three minutes have elapsed, then ad-client recalculates the time before the next advertisement request is to be sent.

As previously described, ad-optimizer 110 may use various criteria to dynamically determine time information for an advertisement, where the time information represents the minimum length of time that the advertisement should be displayed by an ad-client. The set of criteria used for one advertisement may be the same as or different from the set of criteria used for another advertisement. In this manner, the set of criteria used for determining the time information is dynamically changeable based upon the advertisement and other available information. The following paragraphs describe examples of criteria that may be used and the manner in which the criteria affect the computation of time information for an advertisement. The list of criteria described below is not intended to be an exhaustive list; other criteria may be used in alternative embodiments.

### (1) Location or Geography

In one embodiment, the geographical location or position of ad-client 106 or a user of ad-client 106 may be used as a criterion to determine the length of time for displaying an advertisement. The length of time determined for an ad-client or user in one geographic position may be different from the length of time for an ad-client or user positioned in another geographic position. For example, the length of time computed for an ad-client or user in the US may be different from the time computed for an ad-client or user in Canada, which in turn may be different from the length of time computed for an ad-client or user in Brazil, and so on. Even within the US, the time information computed for an ad-client or user in San Francisco may be different from the time information computed for an ad-client or user in Los Angeles.

For example, consider two geographies Canada and Brazil. It may be the case that there is an abundance of advertisement inventory in Canada (i.e., there are a lot of advertisers who want to present their advertisements to users located in Canada) whereas there is very little advertisement inventory in Brazil (i.e., there are only a small number of advertisers who want to present their advertisements in Brazil). In such a scenario, an advertisement may be shown for a greater amount of time in Brazil than in Canada since there is limited availability of advertisements in Brazil. Accordingly, the length of time computed for an advertisement to be displayed by an ad-client located in Brazil may be longer than the length of time determined for an advertisement to be displayed in Canada. For example, in a given period of time, 10 advertisements may be delivered for a user session for a user in Canada, 8 advertisements may be delivered per user session in the US (except in San Francisco where it could be 11), and only 2 advertisements may be delivered in Brazil. For a reduced inventory of advertisements such as in Brazil, displaying an advertisement for a longer period of time may increase the probability that the user will click-through the advertisement. Accordingly, in spite of the reduced inventory, the length of time determined for an advertisement may be such that it maximizes the click rate for the advertisement in that particular geography. In this manner, the advertiser who has purchased the advertisement gets a higher click rate, which in turn translates to higher revenues for the ad-server 108.

Accordingly, in one embodiment, the advertisement inventory (i.e., the number of advertisements available for showing) for a particular geographic region may be used to determine the length of time that an advertisement is shown by a client in that geographic region. The advertisement inventory for a region may represent the interest of advertisers in advertising in that region. In one embodiment, the greater the advertisement inventory for a region, the lesser the amount of time for displaying each advertisement in that region (or the smaller the advertisement inventory for a region, the greater the amount of time for displaying each advertisement in that region).

Different techniques may be used to determine the geographic position of an ad-client or user of the ad-client. According to one technique, a reverse-IP lookup may be performed using the IP address of an ad-client to determine the geographic location of the ad-client. The IP address of the ad-client may be communicated from the ad-client to the ad-optimizer or may be automatically determined by the ad-optimizer from information received by the ad-optimizer from the ad-client. According to another technique, for an ad-client equipped with a GPS locator, the geographic position of the ad-client may be determined using the GPS locator. The GPS location of the ad-client may be communicated from the ad-client to the ad-optimizer.

The geographic location may also be determined based upon where a user of the ad-client has declared or registered his/her location to be. For example, as previously described, a user may have login accounts with certain websites. The registration/login information provided by the user and stored by these websites may be used to determine the geographic location of the user. The information provided by the user may, for example, include the user's location (e.g., home address) and this information may be used for determining the time information for an advertisement. Other information (e.g., language spoken by the user) provided by the user may also be used to deduce a geographic position to be used for the length of time computation for an advertisement. In some embodiments, the geographic information may also be provided by the user, such as during the user's browsing activity (e.g., a message such as “I am having a blast in London” left by the user at a social networking site).

### (2) Website

The average time spent by a user on the Internet on a page view is about 40 seconds. However, this time varies quite substantially from one type of website to another since a user may access pages from different websites with vastly differing characteristics including different usage characteristics. Consider the following three types of sites as examples:

(a) a news site (e.g., www.cnn.com),
(b) an online games site (e.g., www.xbox.com/Live), and
(c) a social network site (e.g., www.facebook.com).
Owing to the difference in the type of content offered by these sites, the manner in which a user interacts with these sites is very different. A user's session with a news site tends on average to be shorter than for the other types of sites. A user may typically load one or two pages from a news site, read one or two articles and then leave the website. The time that a user may spend reading an article on a page may be two or three minutes and the user may flip through 2-3 such pages. Thus, a user at a news site may have an average session time of about 7 minutes, comprised of two or three page views with the user clicking twice (to call pages 2 and 3). This may be very different from the user's interaction with an online gaming website. A user at a game site may have a much longer average session time such as of 50 minutes, turning 5 pages, clicking 20 times and spending 10 minutes per game. This in turn may be different from a user's interaction with a social network site where the user may spend 20 to 30 minutes on the site but change a page every 10 or 15 seconds (consuming 40-50 page views), resulting typically in a much shorter per page time. As another example, consider an online media streaming site such as www.hulu.com where the user may spend 40+ minutes during a session with a very limited number of page views.

Conventional techniques display a new advertisement to the user for every page view. However, this one-size-fits-all approach is far from effective. For example, for a social network site where the user may change a page view every 10-15 seconds, showing a new advertisement to the user upon every page view bombards the user with so many advertisements that practically speaking the user does not have enough time to assimilate and interact with the advertisements. The user may potentially see the first five or six or seven advertisements, but after some time the user just shuts off and ignores (“tunes out”) viewing that area of the page where the advertisements are shown. This is one of the biggest reasons why advertisements shown on social network sites have very low engagement or click-through rates. In a CPC revenue model, decreased click-through rates translate to lower revenues for the ad-server vendor. The advertiser is also not happy since business generated for the advertiser is reduced.

Accordingly, for a social network website, it may be more profitable for the ad-server vendor to increase the length of time that an advertisement is displayed to the user by the ad-client such that the user has sufficient time to assimilate the advertisement and interact with the advertisement. Accordingly, for an advertisement to be displayed during a user's session with a social network site, ad-optimizer 110 may be configured to compute a length of time for the advertisement that is longer than the average per-page time for that website. For example, ad-optimizer 110 may compute a time of 1 minute for the advertisement, which is longer than the 10 seconds average page time. Ad-client 106 may then cause the advertisement to be displayed for at least 1 minute. As the result, an advertisement may be persisted across multiple page views served from the social network site, thereby giving the user more time to assimilate the advertisement and consequently increasing the potential of the user interacting with an advertisement. Likewise, for a games site, ad-optimizer 110 may be configured to compute a length of time (e.g., 5 minutes) for an advertisement that is less than the average time spent per page view. In this instance multiple advertisements may be displayed to the user during a page view, with each advertisement being displayed for a sufficient amount of time that increases the probability of the user interacting with the advertisement thereby increasing the potential revenues for the ad-server vendor. For a news website, a 30 second length of time may be computed, and the like.

In the manner described above, ad-optimizer 110 may be configured to determine a length of time for which an advertisement is to be displayed by the ad-client based upon the site with which the user of the ad-client is having a session. Information related to a website that may be used by ad-optimizer 110 to determine a length of time for an advertisement may include the type of website, click-through rates for advertisements displayed during a session with the website, average session time for the website, average page view rate for the website, content shown by the website, and the like.

Information related to the website may be communicated to ad-optimizer 110 from ad-client 106 or from ad-server 108, or alternatively may be accessible to ad-optimizer 110. For example, website-related information may be communicated from ad-client 106 to ad-optimizer 110 during step (4) depicted in FIG. 3 or step (1) in FIG. 4. Ad-optimizer 110 may then determine a length of time for the advertisement based upon the website information.

In one embodiment, ad-optimizer 110 may store information regarding various categories of website. The categories may be based upon the name of the websites (identified by their URLs), types of content served by the website, usage characteristics of the websites, and various other website-related characteristics. A length of time may be configured for each category. The length of time for a category may be configured such that it maximizes the chance of a user interacting with the advertisement thereby generating increased revenues for the ad-server vendor. Ad-optimizer 110 may then use this information to determine the time information for a specific website identified by ad-client 106. Upon receiving information identifying a website, ad-optimizer may map that website to a particular category and then determine the length of time corresponding to that category. Ad-optimizer 110 may then communicate the length of time to the ad-client.

There are different ways in which a length of time may be configured for a particular website or website category. In one embodiment, this may be determined based upon historical analyses of advertisements displayed during a session with the website. For example, statistics and several user surveys are available (or may be taken) to determine correlations between a website, user click-through rates for the website, and the time for achieving optimal click-through rates. Such studies/surveys may be used to configure the length of time for a website.

The length of time may be customized for a particular type (e.g., social network website versus online gaming websites) of website and/or also for particular websites (e.g., identified by their URLs). Even within a particular category or type of website, different lengths of times may be configured for different specific websites based upon usage characteristics associated with the websites. Further, the length of time configured for a website may also be dynamically changed during a user session based upon the amount of time that the user has spent on that website during a session. In determining a length of time for an advertisement based upon a particular website, ad-optimizer 110 need not know the length of time of the user's session with the website.

Ad-optimizer 110 is configured to determine a length of time on a per-advertisement basis and communicate the information to ad-client 106. In this manner, ad-optimizer 110 customizes the length of time for each individual advertisement. The length of time computed for an advertisement displayed during a user's session with a first website may be different from the amount of time computed for the same advertisement displayed during the user's session with a second website that is different from the first website. Further, during a user's session with a website, the length of time determined by ad-optimizer 110 for a first advertisement displayed by ad-client 106 may be different from the length of time determined for a second advertisement displayed by the ad-client 106 during the user's session with the same website. In this manner, the ad rotation rate may be dynamically changed and controlled during the user's session with a website. For example, advertisements may be rotated slower towards the front end of the user session and faster during the lag end of the user session.

### (3) User Characteristics

In one embodiment, ad-optimizer 110 may be configured to use information related to a user of the ad-client to determine a length of time for which an advertisement is to be displayed by the ad-client. It is known that different users respond differently to online advertisements. For example, studies have shown that men consistently take on an average 15 seconds longer to generate a click-through for an advertisement when compared to women. Given this information, in order to increase the chance of a click-through for an advertisement, the advertisement should be shown for a longer time duration where the ad-client user is a man than for a woman user. Such ad-client user-related characteristics may be used by ad-optimizer 110 to determine the length of time for which an advertisement is to be displayed by the ad-client. The user-related information may include but is not restricted to information about the user's gender, age, profession, salary, marital status, hobbies, website commonly visited by the user, and other information.

Ad-optimizer 110 may receive information related to a user from ad-client 106 or from ad-server 108. In one embodiment, information related to an ad-client user may be communicated by ad-client 106 to ad-optimizer 110 during step (4) depicted in FIG. 3 and step (1) in FIG. 4. This may include information provided by the user registration (e.g., account opening) with one or more websites. In other embodiments, the information may be solicited from the user by ad-client 106 and sent to ad-optimizer 110. Ad-optimizer 110 may also access user-related information from one or more websites that store user information, such as information captured when a user opens an account with a website.

### (4) Advertisement Creative (Ad Creative)

The term “ad creative” is generally used to refer to the design and content of an advertisement. Different characteristics related to an ad creative may be used by ad-optimizer 110 to determine the length of time for which the corresponding advertisement is to be displayed. In one embodiment, ad-optimizer 110 determines the length of time for an advertisement that optimizes the revenue potential for the ad-server vendor.

Different ad creatives may generate different response rates based upon the time the corresponding advertisements are displayed to a user. For example, an ad creative 1, when shown for an additional 10 seconds may increase yield (e.g., click-through rate) by 50%, whereas ad creative 2 when shown for an additional 10 seconds may not generate any additional economic value. In a CPC revenue model wherein increased click-through rates translate to increased revenues for the ad-server vendor, it is economically lucrative to show ad creative 1 for a longer period of time as compared to ad creative 2. As another example, it may be the case that for a movie ad creative, people either respond to it right away (e.g., within the first 10 seconds) or never do. Accordingly, there is no point in displaying a movie advertisement beyond a certain time period, say 10 seconds. This type of response-related information related to ad creatives may be used to set the time for how long advertisements are to be displayed to increase the probability that a user clicks-through the advertisements.

Different ad creatives may also have different associated revenue generation capabilities for an ad-server vendor. For example, consider two ad creatives: (a) a movie advertisement which has a lower per click/engagement fee and (b) a financial services ad creative which when engaged provides a higher fee. Ad-optimizer 110 may be configured to display the financial services advertisement for a longer period of time than the movie advertisement to increase the probability of an advertisement engagement. Accordingly, the length of time for which the advertisement is displayed may be dynamically varied by ad-optimizer 110 based upon the revenue generation capability of the ad creative.

In one embodiment, ad-optimizer 110 may determine the length of time for an advertisement by optimizing revenue generation potential within a fixed time period. For example, if it is known that a user session is going to last only for another five minutes, ad-optimizer 110 may present an advertisement that maximizes revenue for the ad-server vendor within the five minutes. For example, it may be known that between two advertisements, a first advertisement has the potential to provide more revenue than a second advertisement during the remaining time (e.g., 5 minutes) left. In this scenario, ad-optimizer 110 may determine a higher percentage of the remaining time for displaying the first advertisement as opposed to the second advertisement.

In the manner described above, ad-optimizer 110 may use various characteristics related to ad creatives to determine a length of time for which an advertisement is to be displayed. Ad-optimizer 110 may receive information related to an advertisement from ad-client 106 (e.g., during step (4) in FIG. 3) or from ad-server 108. Alternatively, information related to different ad creatives may be provided to ad-optimizer 110 and used by ad-optimizer 110.

There are different ways in which a length of time may be configured for a particular ad creative. In one embodiment, this may be done based upon historical data for the ad creative. For example, historical data may be collected for an ad creative correlating the display time for the ad creative to associated time-based click rates. A graphical tool (e.g., a histogram) may be plotted using the data and used to determine an optimal length of time for displaying the ad creative that maximizes the click-through rate for the advertisement, which in turn maximizes the revenue potential for the ad-server vendor.

### (5) Advertisement Campaigns

Different advertisement campaigns may be directed to different user demographics and an ad-server vendor may be paid more upon achieving a particular advertisement campaign goal (e.g., success rate as measured by click-through rates) directed to a particular demographic. For example, a particular advertisement campaign may be directed to users aged 18-25. Based upon the campaign information, information related to the group demographic, and present status of the advertisement campaign, ad-optimizer 110 may set an appropriate time for displaying an advertisement for a user falling within that demographic to increase the success rate of that advertisement campaign, which in turn translates to increased revenues for the ad-server vendor.

### (6) Next Advertisement to be Delivered

In some embodiments, in addition to the current advertisement being displayed by ad-client 106, ad-optimizer 110 may also have knowledge about the next advertisement that will be served to ad-client 106 for display. Ad-optimizer 110 may use this information related to the next advertisement to determine a length of time that the current advertisement is to be displayed by ad-client 106.

As described above, ad-optimizer 110 may use several different criteria to determine the minimum length of time for which an advertisement is to be output by ad-client 106. Further, the time determination may be performed to optimize various different goals. In one embodiment, the goal is to maximize the revenue potential for the ad-server vendor. Optimization for other goals may be performed in alternative embodiments.

Various different optimization techniques may be used by ad-optimizer 110 to determine the length of time for an advertisement. According to one embodiment, a hierarchy or laddering optimization technique may be used. In this technique, a priority may be assigned to each criterion in the set of criteria and the criteria may then be ordered (or organized into a hierarchy) according to their associated priorities. The priority-ordered list may then be used by ad-optimizer 110 to determine the length of time for an advertisement.

For example, let set C={C1, C2, C3, . . . , Cn} represent a set of criteria available to ad-optimizer 110 for determining a length of time for an advertisement. Priorities may be assigned to each criterion such that C1 has the highest priority, C2 has a lower priority than C1, C3 has a lower priority than C2, and so on (with Cn having the lowest priority). Each criterion may also have an associated length of time specified for the criterion or alternatively an associated method to be used for determining a length of time using that criterion.

In this embodiment, the criteria may be ordered based upon their associated priorities. The ordered list of criteria may be traversed, starting with the highest priority criterion, to determine a specific criterion to be used for determining the length of time for an advertisement. For example, if information for criterion C1 is available, then the time specified for C1 is used or alternatively a computation method associated with C1 is used to determine a length of time for displaying an advertisement. If information for C1 is not available, then it is determined if information for C2 is available and, if available, the time specified for C2 or a computation method associated with C2 is used to determine a length of time for displaying an advertisement. If information for C2 is not available, then C3 is used, and so on. In this manner, the ordered list of criteria is traversed starting with the highest priority criterion to determine the criterion to be used for determining the length of time for an advertisement. The time information associated with the selected criterion or a computation method associated with the selected criterion is used to determine the length of time for an advertisement. A default length of time or default method may be specified and used to determine the length of time if information is not available for any configured criteria.

In the above-described technique, the ordering of criteria, the time or method associated with each criterion, and the default length of time or method are all customizable. In one embodiment, these parameters may be customized by the ad-server vendor to optimize revenue generation for the ad-server vendor.

For example, in one embodiment, the criteria may be ordered as follows:

1. geography location (highest priority)
2. then website
3. then user-related attributes
4. then ad creative (lowest priority)
In this embodiment, upon receiving a request from ad-client 106 for time information for an advertisement, ad-optimizer 110 may first determine if information indicating a geographical location of the ad-client 106 or user of ad-client 106 is available. If geography information is available, then the length of time may be determined based upon the geography information. If geography information is not available, then ad-optimizer 110 may check if information related to a website with which the user is having a session is available, and if so, the website information is used to determine a length of time for the advertisement. If website information is not available, then ad-optimizer 110 may check if information related to attributes of the user of ad-client 106 is available, and if so, the user attributes information is used to determine a length of time for the advertisement. If the user attributes information is not available, then ad-optimizer 110 may check if information related to the ad creative corresponding to the advertisement is available, and if so, the ad creative information is used to determine a length of time for the advertisement. If ad creative information is also not available, then ad-optimizer 110 may use a default time value or use a default method to determine a length of time for the advertisement.

In the technique described above, a single criterion is selected and then used to determine the length of time for an advertisement. In an alternative embodiment, the length of time determined for an advertisement may be computed based upon times computed for one or more criteria. For example, the following equation may be used in one embodiment:

Length of time=W1t_{C1}+W2t_{C2}+ . . . +Wnt_{Cn}

where
t_{Cx}—is the length of time computed using criterion Cx, and
Wx—is a weight corresponding to criterion Cx to increase/decrease the impact of t_{Cx}.

Using the above equation, the length of time for an advertisement may be computed using a combination of times determined based upon multiple criteria. Appropriate weights may be assigned to emphasize or de-emphasize the impact of a particular criterion. A zero weight may be used to eliminate a particular criterion from the computation. The manner in which t_{Cx} is computed is customizable, for example by the ad-server vendor. The individual weights (Wx) are also customizable to meet a particular goal. In one embodiment, these may be customized to optimize the revenue generation potential for the ad-server vendor. The techniques for determining times and the weights may also be dynamically varied.

According to yet another embodiment, multiple equations, each identifying a method for determining a length of time, may be provided. The different equations may have different criteria and different weights. A decision tree may be provided and used to determine which particular equation from the multiple equations is to be used for a given advertisement. Various different selection criteria may be used to determine which specific equation is to be used. The selection criteria may or may not overlap with the criteria for determining the length of time for an advertisement. In one embodiment, the selection criteria may be applied to the decision tree to determine a specific equation to be used, and the selected equation may then be used to determine the minimum length of time for outputting an advertisement.

In the manner described above, ad-optimizer 110 may use different techniques to determine a length of time for displaying an advertisement. The various techniques are customizable, for example by an ad-server vendor. This enables the ad-server vendor to completely control how long an advertisement is to be displayed by ad-client 106. This in turn enables the ad-server vendor to control the rotation of advertisements.

In one embodiment, a customized output time is determined on a per-advertisement basis to increase the likelihood that a user actually interacts/engages the advertisement so as to increase the revenue potential for the ad-server vendor. These customized computations result in advertisements having higher click/interaction/engagement rates. This in turn results in higher revenues for an ad-server vendor such as Meebo™ (since it increases the revenue-per-session-per user or revenue-per-minute or revenue-per-page view for a website). Advertisers also benefit since it increases the yield rate and success rate for their advertisements. It also provides for better inventory utilization (and therefore for a given amount of revenue, lower number of ad impressions per user) because the fine-grained usage characteristics are taken into account when determining the minimum length of time for displaying an advertisement. This tailored approach is a substantial improvement over the one-size-fits all approach used by conventional techniques. Increased revenues for ad-server vendors enable them to offer lower prices to advertisers for advertisement engagements because user attention and advertisement inventory can be used more efficiently.

According to an embodiment of the present invention, the delivery of advertisements is decoupled from the delivery of page views. This is particularly relevant for page view driven sites, which in the past delivered advertisements on a per page view basis. The delivery of advertisements for such page view-based sites can now be completely decoupled from the delivery of the pages.

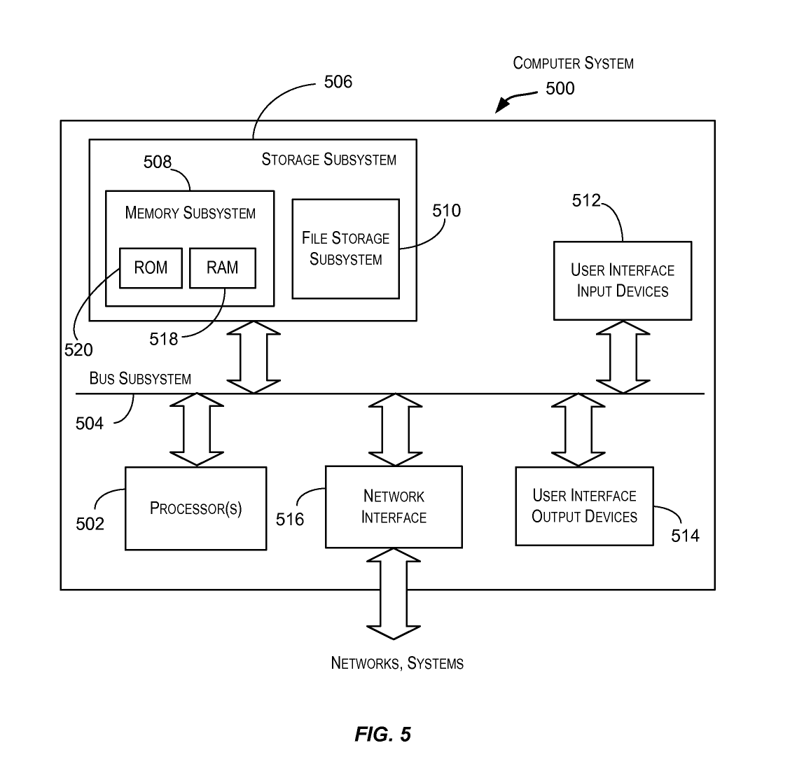

FIG. 5 is a simplified block diagram of a computer system 500 that may be used to practice an embodiment of the present invention. In various embodiments, computer system 500 may be used to implement any of the systems illustrated in FIG. 1 and described above. For example, computer system 500 may be used as ad-client 106, ad-server 108, or ad-optimizer 110. As shown in FIG. 5, computer system 500 includes a processor 502 that communicates with a number of peripheral subsystems via a bus subsystem 504. These peripheral subsystems may include a storage subsystem 506, comprising a memory subsystem 508 and a file storage subsystem 510, user interface input devices 512, user interface output devices 514, and a network interface subsystem 516.

Bus subsystem 504 provides a mechanism for enabling the various components and subsystems of computer system 500 to communicate with each other as intended. Although bus subsystem 504 is shown schematically as a single bus, alternative embodiments of the bus subsystem may utilize multiple busses.

Network interface subsystem 516 provides an interface to other computer systems and networks. Network interface subsystem 516 serves as an interface for receiving data from and transmitting data to other systems from computer system 500. For example, network interface subsystem 516 may enable a user computer to connect to the Internet and facilitate communications using the Internet.

User interface input devices 512 may include a keyboard, pointing devices such as a mouse, trackball, touchpad, or graphics tablet, a scanner, a barcode scanner, a touch screen incorporated into the display, audio input devices such as voice recognition systems, microphones, and other types of input devices. In general, use of the term “input device” is intended to include all possible types of devices and mechanisms for inputting information to computer system 500.

User interface output devices 514 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 500. An advertisement may be output by computer system 500 using one or more of user interface output devices 514.

Storage subsystem 506 provides a computer-readable storage medium for storing the basic programming and data constructs that provide the functionality of the present invention. Software (programs, code modules, instructions) that when executed by a processor provide the functionality of the present invention may be stored in storage subsystem 506. These software modules or instructions may be executed by processor(s) 502. Storage subsystem 506 may also provide a repository for storing data used in accordance with the present invention. Storage subsystem 506 may comprise memory subsystem 508 and file/disk storage subsystem 510.

Memory subsystem 508 may include a number of memories including a main random access memory (RAM) 518 for storage of instructions and data during program execution and a read only memory (ROM) 520 in which fixed instructions are stored. File storage subsystem 510 provides a non-transitory persistent (non-volatile) storage for program and data files, and may include a hard disk drive, a floppy disk drive along with associated removable media, a Compact Disk Read Only Memory (CD-ROM) drive, an optical drive, removable media cartridges, and other like storage media.

Computer system 500 can be of various types including a personal computer, a portable computer, a workstation, a network computer, a mainframe, a kiosk, a server or any other data processing system. Due to the ever-changing nature of computers and networks, the description of computer system 500 depicted in FIG. 5 is intended only as a specific example for purposes of illustrating the preferred embodiment of the computer system. Many other configurations having more or fewer components than the system depicted in FIG. 5 are possible.

Although specific embodiments of the invention have been described, various modifications, alterations, alternative constructions, and equivalents are also encompassed within the scope of the invention. Embodiments of the present invention are not restricted to operation within certain specific data processing environments, but are free to operate within a plurality of data processing environments. Additionally, although embodiments of the present invention have been described using a particular series of transactions and steps, it should be apparent to those skilled in the art that the scope of the present invention is not limited to the described series of transactions and steps.

Further, while embodiments of the present invention have been described using a particular combination of hardware and software, it should be recognized that other combinations of hardware and software are also within the scope of the present invention. Embodiments of the present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention.

What is claimed is:

1. A method comprising:
determining, by a first system, first time information for a first advertisement based upon a set of one or more criteria, the first time information indicative of a length of time for outputting the first advertisement at a client system; and
communicating the first time information from the first system to the client system.

2. The method of claim 1 further comprising:
causing, by the client system, the first advertisement to be output by the client system for at least the length of time indicated by the first time information.

3. The method of claim 2 wherein multiple web pages are loaded by the client during the first advertisement being output by the client system.

4. The method of claim 1 wherein the determining comprises:
determining the first time information responsive to a request received from the client system requesting a length of time for the first advertisement.

5. The method of claim 1 further comprising:
determining, by the first system, second time information for a second advertisement based upon the set of one or more criteria, the second time information indicative of a length of time for outputting the second advertisement at the client system; and
communicating the second time information from the first system to the client system;
wherein the length of time indicated by the first time information is different from the length of time indicated by the second time information.

6. The method of claim 5 further comprising:
outputting, by the client system, the first advertisement for at least a length of time indicated by the first time information; and
outputting, by the client system, the second advertisement for at least a length of time indicated by the second time information;
wherein the first advertisement and second advertisement are output by the client system while the client system is engaged in a session with a first website during which one or more web pages from the first website are loaded and displayed by the client system.

7. The method of claim 1 wherein the set of criteria comprises at least one of a geographic location of the client system or of a user of the client system, information related to the user of the client system, information related to a website, characteristics of the first advertisement, a campaign goal for the first advertisement, or a second advertisement to be displayed after the first advertisement.

8. The method of claim 1 wherein the determining comprises:
determining, by the first system, the first time information based upon a geographical location associated with the client system or a user of the client system.

9. The method of claim 1 wherein the determining comprises:
determining, by the first system, the first time information based upon information related to a user of the client system.

10. The method of claim 1 wherein the determining comprises:
determining, by the first system, the first time information based upon information related to a website.

11. The method of claim 1 wherein the determining comprises:
determining, by the first system, the first time information based upon information related to the first advertisement.

12. The method of claim 1 wherein the determining comprises:
selecting, by the first system, a first criterion from the set of criteria; and
determining, by the first system, the first time information based upon the selected first criterion.

13. The method of claim 12 wherein the selecting comprises selecting a criterion from the set of criteria based upon a priority assigned to each criterion in the set of criteria.

14. A computer-readable storage medium storing a plurality of instructions for controlling a processor, the plurality of instructions comprising:
instructions that cause the processor to determine first time information for a first advertisement based upon a set of one or more criteria, the first time information indicative of a length of time for outputting the first advertisement at a client system; and
instructions that cause the processor to communicate the first time information to the client system.

15. The computer-readable storage medium of claim 14 wherein the plurality of instructions further comprises instructions that cause the client system output to the first advertisement for at least the length of time indicated by the first time information.

16. The computer-readable storage medium of claim 14 wherein the instructions that cause the processor to determine the first time information further comprise instructions that cause the processor to determine the first time information responsive to a request received from the client system requesting a length of time for the first advertisement.

17. The computer-readable storage medium of claim 14 wherein the plurality of instructions further comprises:
instructions that cause the processor to determine second time information for a second advertisement based upon the set of one or more criteria, the second time information indicative of a length of time for outputting the second advertisement at the client system; and
instructions that cause the processor to communicate the second time information to the client system;
wherein the length of time indicated by the first time information is different from the length of time indicated by the second time information.

18. The computer-readable storage medium of claim 14 wherein the set of criteria comprises at least one of a geographic location of the client system or of a user of the client system, information related to the user of the client system, information related to a website, characteristics of the first advertisement, a campaign goal for the first advertisement, or a second advertisement to be displayed after the first advertisement.

19. The computer-readable storage medium of claim 14 wherein the instructions that cause the processor to determine the first time information comprise:
instructions that cause the processor to determine the first time information based upon a geographical location associated with the client system or a user of the client system.

20. The computer-readable storage medium of claim 14 wherein the instructions that cause the processor to determine the first time information comprise:
instructions that cause the processor to determine the first time information based upon information related to a user of the client system.

21. The computer-readable storage medium of claim 14 wherein the instructions that cause the processor to determine the first time information comprise:
instructions that cause the processor to determine the first time information based upon information related to a website.

22. The computer-readable storage medium of claim 14 wherein the instructions that cause the processor to determine the first time information comprise:
instructions that cause the processor to determine the first time information based upon information related to the first advertisement.

23. The computer-readable storage medium of claim 14 wherein the instructions that cause the processor to determine the first time information comprise:
instructions that cause the processor to select a first criterion from the set of criteria; and
instructions that cause the processor to determine the first time information based upon the selected first criterion.

24. The computer-readable storage medium of claim 23 wherein the instructions that cause the processor to select comprise instructions that cause the processor to select a criterion from the set of criteria based upon a priority assigned to each criterion in the set of criteria.

25. A system comprising:
a memory; and
a processor coupled to the memory, the processor configured to:
determine first time information for a first advertisement based upon a set of one or more criteria, the first time information indicative of a minimum length of time for outputting the first advertisement at a client system; and
communicate the first time information to the client system.
